(19) United States
(12) Patent Application Publication
(10) Pub. No.: US 2025/0003875 A1
(43) Pub. Date: Jan. 2, 2025

(54) Measurement of Bidirectional Reflectance Distribution

(71) Applicant: DATACOLOR INC., Lawrenceville, NJ (US)

(72) Inventor: Zhiling Xu, Princeton Junction, NJ (US)

(73) Assignee: DATACOLOR INC., Lawrenceville, NJ (US)

(21) Appl. No.: 18/344,085

(22) Filed: Jun. 29, 2023

(51) Int. Cl. G01N 21/57

(52) U.S. Cl. CPC G01N 21/57; G01N 2201/0636

(57) ABSTRACT

When a light beam hits an opaque sample, the sample will reflect light towards various directions with various intensities back into the 2π hemisphere above the sample plane. Bidirectional Reflectance Distribution Function (BRDF) can be used to describe such a property of the sample. A hemi-spherical screen is used to collect the light in the 2π hemisphere, and a pin-hole imaging system can be used to map the intensity of light distributed in the 2π hemisphere into a 2-dimensional image. From this 2-dimensional image, the BRDF of the sample material can be obtained.

### FIELD OF THE INVENTION

The present invention is directed to an apparatus, systems and methods for obtaining and analyzing the surface properties of a sample, including the sample's bidirectional reflectance distribution function.

### BACKGROUND OF THE INVENTION

When a beam of light hits an opaque surface, part of the light will be absorbed, and the rest will be reflected towards various directions. Bidirectional Reflectance Distribution Function (BRDF) describes how much light at given incident directions is reflected at given directions when light makes contact with a certain material.

Traditionally, BRDF can be measured with a goniometer that requires a moveable detector that can measure light signal at different directions. However, the measurement process is time consuming because there are so many directions to cover in order to get a full picture of BRDF.

Efforts have been made to simplify the measurement process by using a hemi-spherical screen, a convex mirror and a camera. For example, such approaches have been described in the conference paper “The Imaging Sphere—the First Appearance Meter?” and U.S. Pat. No. 8,077,319 B2, both incorporated herein by reference as if presented in their respective entireties.

However, what is needed in the art is a relatively straight forward measurement configuration and arrangement that can measure the BRDF of a surface.

Furthermore, what is needed in the art is an apparatus, system and method that avoids the use of a specially designed sphere or spherical reflector(s) and complicated imaging optical systems to measure BRDF.

### SUMMARY OF THE INVENTION

In one or more implementations, an apparatus, system or method is provided to measure the BRDF of a surface by using a hemi-spherical screen, a pin hole or the like, and one or more image sensors. This approach avoids the use of a specially designed sphere reflector and complicated imaging optical systems, and thus the cost of construction and operation are reduced relative to prior art and competing solutions. Alternatively, in one or more arrangements, an apparatus, system or method is provided to measure the BRDF of a surface using a parabolic reflector, thus further improving the signal/noise ratio of the resulting measurement.

It will be appreciated by those possessing an ordinary level of skill in the art that when a light beam hits an opaque sample, the sample will reflect light towards various directions with various intensities back into the 2π hemisphere above the sample plane. Bidirectional Reflectance Distribution Function (BRDF) can be used to describe such a property of the sample. In the described arrangement, a hemi-spherical screen is used to collect the light in the 2π hemisphere, and a pin-hole imaging system can be used to map the intensity of light distributed in the 2π hemisphere into a 2-dimensional image. From this 2-dimensional image, the BRDF of the sample material can be obtained.

In one or more particular implementations of the disclosure provided herein, an apparatus for measuring the characteristics of a sample is provided comprising: an enclosure about an interior volume containing the sample, wherein the enclosure has a reflective inner surface and at least two openings; a light source configured to illuminate the sample within the enclosure such that light reflected from the sample and the inner surface of the enclosure passes through the at least two openings to an external environment; at least two image sensors configured to generate output data in response to light striking a portion thereof, where the at least two image sensors are positioned to receive light exiting the at least two openings disposed within the enclosure; and a processor configured to receive the output data from the at least two image sensors and generate, using the output data, a bidirectional reflectance distribution function (BRDF) property of the sample.

In yet a further implementation, the described apparatus is further configured to output the BRDF value to one or more of a display device coupled to the processor, internal storage device accessible by the processor, or remote storage that is remotely accessible by the processor.

It will be further appreciated that the inner surface of the enclosure is a light scattering material, such as a diffuse white material.

In yet a further implementation of the BRDF measurement device, system and method described, the enclosure further includes a base configured to support the sample and the enclosure, wherein the base is formed of a light absorbing material. In a particular implementation, the light source is located outside the enclosure and the enclosure is configured with at least one light transparent portion to allow the light from the light source to reflect off the sample. In a further configuration, one or more reflective elements are located adjacent to each of the at least two openings. In yet a further configuration, a light absorbing device is positioned between the sample and a portion of the inner surface of the enclosure and configured to absorb light reflected off the sample.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 details one or more components of the BRDF measurement instrument system as described herein;

FIG. 2 details the modules of the BRDF measurement system as described herein;

FIG. 3 provides a flow diagram of the measurement process described herein;

FIG. 4 details one or more configurations of the BRDF measurement system described herein;

FIG. 5 details one or more configurations of the BRDF measurement system described herein;

FIG. 6 details one or more configurations of the BRDF measurement system described herein;

FIG. 7 details one or more configurations of the BRDF measurement system described herein;

FIG. 8 details one or more configurations of the BRDF measurement system described herein;

FIG. 9 details one or more configurations of the BRDF measurement system described herein;

FIG. 10 details one or more configurations of the BRDF measurement system described herein;

FIG. 11 details one or more configurations of the BRDF measurement system described herein; and

FIG. 12 a component of one or more configurations of the BRDF measurement system described herein.

### DETAILED DESCRIPTION OF CERTAIN EMBODIMENTS OF THE INVENTION

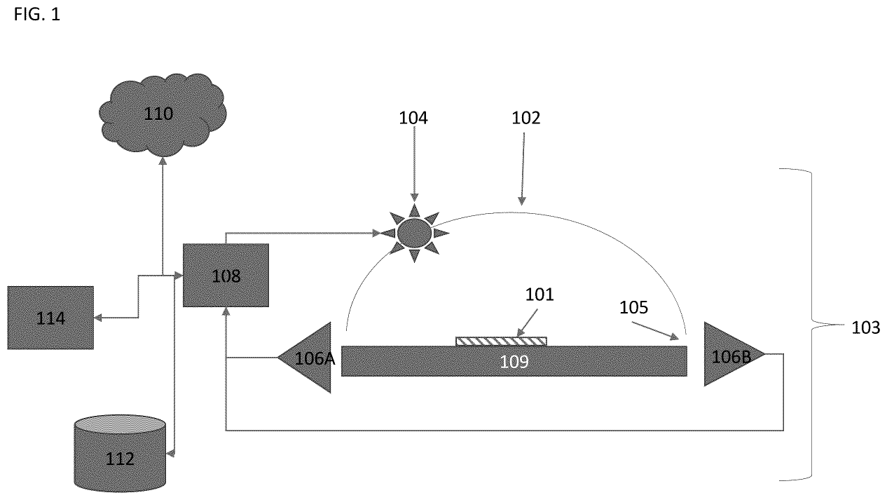

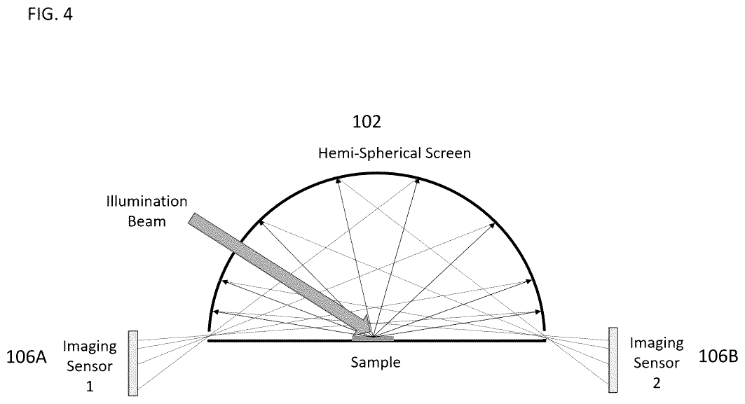

By way of overview and introduction, various embodiments of the apparatus, systems and methods described herein are directed towards the measurement of the Bidirectional Reflectance Distribution Function (BRDF) of a surface. For example, a sample material or object is put at the bottom center of a hemi-spherical screen. When an illumination beam hits the sample, the sample reflects light towards various directions according to its Bidirectional Reflectance Distribution Function (BRDF) property. The reflected light will hit the inside of the hemi-spherical screen, and the screen will scatter light towards various directions. The intensity of light scattered from the screen at different locations depends on the BRDF function of the sample material. At least two small pin holes, at 180 degrees from one another on the hemi-spherical screen, are used to channel light. For example, when looked at in cross-section (such as in FIGS. 1 and 4) light from the right-half of the hemi-spherical screen can go through the left pin hole and reach a first imaging sensor, and light from the left-half of the hemi-spherical screen can go through the right pin hole and reach a second imaging sensor.

In general, the first imaging sensor can capture the light distribution information of the right-half of the hemi-spherical screen, and the second imaging sensor can capture the light distribution information of the left-half of the hemi-spherical screen.

The intensity of the light captured by the imaging sensors is determined by the intensity of the light reflected from the sample to the hemi-spherical screen and is further determined by the BRDF of the sample. The combination of first and second imaging sensors provide a full picture of the light distribution on the hemi-spherical screen, and thus provide a full picture of the BRDF of the sample related to the given direction of incident illumination beam.

The described approach avoids the need to use specially designed measurement devices. For example, the BDRF device described does not need to use a sphere reflector and other complicated imaging optical systems. Through the use of a hemi-spherical screen equipped with one or more openings and one or more image devices, BRDF measurements can be obtained that are equivalent to those obtained using specialty devices, but with reduced complexity and cost. Furthermore, using a parabolic reflector instead of a hemi-spherical enclosure allows for an improvement of the signal/noise ratio and, in turn, an improved measurement.

Without being tied to any particular theory, the described apparatus, system and method provides a light source that is configured to direct a light beam towards an opaque sample. Then, if the sample has reflective surface properties, the light will reflect towards various directions with various intensities, for example as shown by the arrows of FIGS. 4-11. By enclosing the sample within a semi-hemispherical, or other suitable enclosure geometry, the light reflected off of the sample will travel back into the 2π hemisphere above the sample plane. Bidirectional Reflectance Distribution Function (BRDF) can be used to describe such a property of the sample. Through the use of a hemi-spherical screen to collect the light in the 2π hemisphere, a pin-hole imaging system can be used to map the intensity of light distributed in the 2π hemisphere into a 2-dimensional image. From this 2-dimensional image, the BRDF of the sample material can be obtained.

As shown, FIG. 1 illustrates the elements of one embodiment of the BDRF measurement system described. In one or more particular implementations, the BRDF measurement device includes a measurement enclosure 103. For example, as shown in FIG. 1, measurement enclosure 103 including a hemi-spherical screen 102 is used to enclose a sample under analysis 101 placed on a base or platform 109. In one or more implementations, the base or platform 109 are part of the same structure or enclosure device 103. However, in alternative configurations or embodiments, the hemi-spherical screen 102 is provided separately from the base 109. In this configuration, base 109 can be any flat or semi-flat surface, such as a work bench, testing platform, table top or other similar device or article.

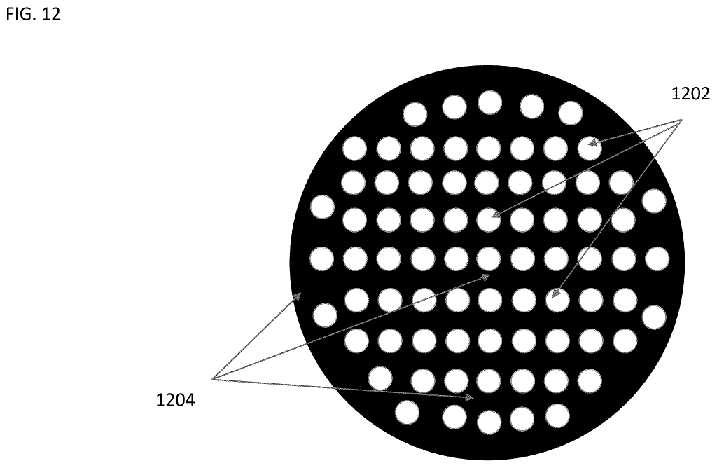

In a particular implementation, the inner surface of the hemi-spherical screen 102 is coated with a reflective surface. In another arrangement, the inner surface is coated with a matte or other surface treatment. In a further arrangement, as shown in FIG. 12, the inner surface of the hemi-spherical screen 102 is coated with a pattern of both reflective portions 1202 and non-reflective portions 1204.

In a particular implementation, the hemi-spherical screen 102 is equipped with one or more pinholes, channels, passages or other conduits 105 that allow light to exit the interior space enclosed by the hemi-spherical screen 102.

In a further implementation, the hemi-spherical screen 102 is configured with multiple holes or slots (not shown) that allow the illumination to enter the interior volume enclosed by the hemi-spherical screen at different angles/directions. For example, the hemi-spherical screen is equipped with a number of attachment points that allow for an illuminator to be secured at different angles relative to sample 101. In a further arrangement, the hemi-spherical screen 102 can be diffuse white material, or can be other colors of material or different materials with various light scattering properties.

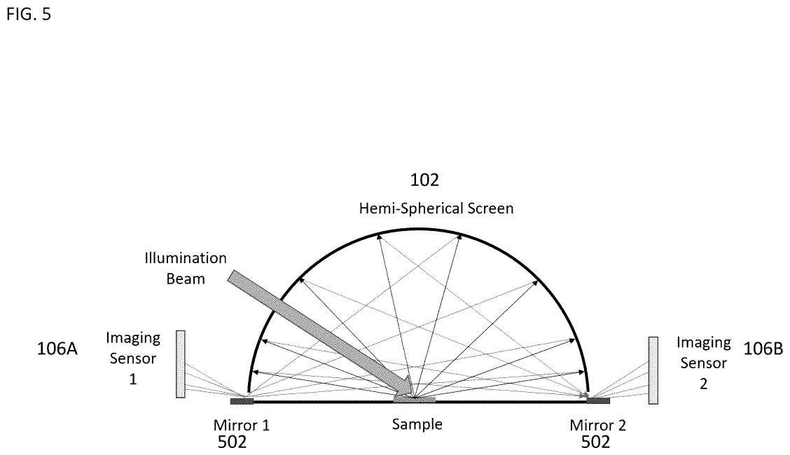

As shown in FIG. 5, in one or more implementations, mirrors or other reflective devices 502 are placed at the channels or passages 105. In this arrangement, light that was directed to the passages, is reflected on to the sample measurement sensors 106A and 106B. In this configuration, the sample measurement sensors 106A-B do not need to be located, fully or partially, below the plane of sample 101. Thus, the measurement device 103 can sit on a counter or be packaged into a portable or semi-portable form factor.

In yet a further implementation, base 109 is a white material. In another arrangement, base 109 is a black material or another material that absorbs light to reduce stray light scattered back onto the hemi-spherical screen 102.

In one or more implementations, sample 101 can be any type or form of physical article having color or spectral properties in need of analysis. For ease of reference and discussion, the foregoing descriptions the sample 101 refers to an article or material that has stable and uniform color and can be evaluated by currently available spectrophotometers.

In one or more further or alternative implementations, sample 101 is a calibration article. Here, the calibration article has specific properties making it suitable for stable measurements over time. For instance, sample 101 is a ceramic calibration tile. In one or more further implementations, sample 101 is a white ceramic calibration tile. However, in alternative configurations, sample 101 is a black calibration tile. Furthermore, sample 101 can be any color calibration tile that shares specular similarities with a black calibration tile, such as dark grey or dark blue calibration tiles.

With continued reference to FIG. 1, measurement enclosure 103 includes at least one (1) illuminator 104 configured to illuminate the sample 101. In one arrangement, the at least one illuminator 104 is integrated within the hemi-spherical screen 102. In one or more alternative configurations, the illuminator 104 is positioned outside of the hemi-spherical screen 102. In this configuration, the hemi-spherical screen 102 includes one or more light passages, windows or transmission elements that allow light to pass from the illuminator 104 to the sample 101.

In one or more implementations or embodiments, the one or more illuminator(s) 104 is one or more commercially available lighting sources. For instance, the illuminator 104 is a single lighting element. However, in alternative implementations, the illuminator 104 is a collection of separate lighting devices that are configurable to produce a light with certain spectral power distributions. For instance, the illuminator 104 can, in one implementation, be one or more discrete light emitting elements, such as LEDs or OLEDs; fluorescent, halogen, xenon, neon, fluorescent, mercury, metal halide, HPS, or incandescent lamp; or other commonly known or understood lighting sources. In one arrangement, the illuminator 106 is one or more broad-band LEDs.

In one or more implementations, the illuminator 104 includes a lens, filter, screen, enclosure, or other elements (not shown) that are utilized in combination with the light source of the illuminator 104 to direct a beam of illumination, at a given wavelength, to the sample 101.

In a particular implementation, the illuminator 104 is operable or configurable by an internal processor or other control circuit. Alternatively, the illuminator 104 is operable or configurable by a remote processor or control device having one or more linkages or connections to the illuminator 104. As shown in FIG. 1, illuminator 104 is directly connected to a processor or computer 108.

In one or more implementations illuminator 104 is positioned relative to the hemi-spherical screen 102 and sample 101 in a configuration that causes light directly emitted by the illuminator 104 to strike the sample 101. For instance, light emitted by illuminator 104 is directed to strike the surface of sample 101 at an angle of less than 90-degrees. However, illuminator 104 can be configured to generate illumination that strikes the sample at any angle between 0 and 90-degrees.

Continuing with FIG. 1, light reflected off sample 101 (such as a sample under analysis or a calibration tile) is captured or measured by one or more measurement devices, such as sample measurement sensors 106A-B. Here, sample measurement sensors 106A-B can be an image capture device. For example, the sample measurement sensors 106A-B are image sensors, such as CMOS or CCD image sensors. However, alterative image sensors are appreciated and understood.

In a particular implementation, sample measurement sensors 106A-B is configured to generate an output signal upon light striking a light sensing portion thereof. By way of non-limiting example, the sample measurement sensors 106A-B are configured to output signals in response to light that has been reflected off the sample 102 then strikes a light sensor or other sensor element integral or associated with sample measurement sensors 106A-B.

As shown in FIG. 1 the sample measurement sensors 106A-B are configured to transmit one or more measurements to a processing platform, such as processor 108. In one or more configurations, at least one sample measurement sensor 106 is directly connected to processor 108. However, in one or more implementations, one or more sample sensors 106A-B are equipped or configured with network interfaces or protocols usable to communicate over a network, such as the internet. In this configuration, measurements made by sample measurement sensors 106 are sent to a remote processor for evaluation and analysis.

Alternatively, at least one sample measurement sensor 106 is connected to one or more computers or processors, such as processor 108, using standard interfaces such as USB, FIREWIRE, Wi-Fi, Bluetooth, and other wired or wireless communication technologies suitable for the transmission measurement data.

In one configuration, the sample measurement sensors 106A-B are positioned relative to the hemi-spherical screen such that light that exits the channels 105 strikes a surface of the sample measurement sensors 106A-B. In one configuration, the sample measurement sensors 106A-B are positioned slightly below the plane of the channels 105. In one configuration, the sample measurement sensors 106 are positioned along the plane of the channels 105.

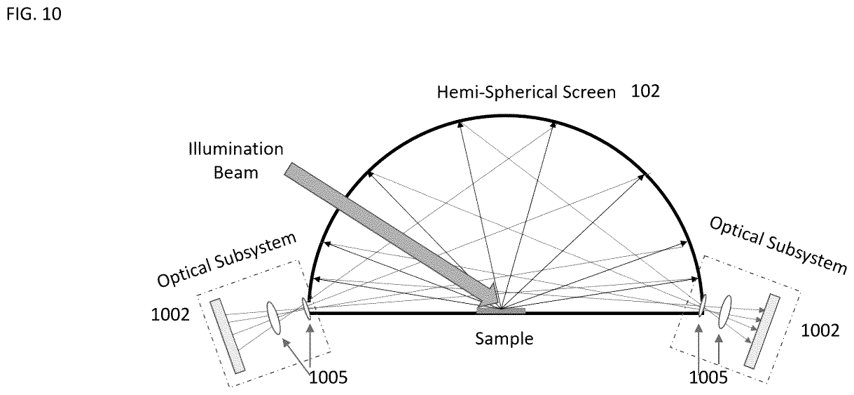

As shown in FIG. 10, an optical subsystem 1002 can be used instead of mirrors or other elements at channels 105 to direct the light to the sample measurement sensors 106A and 106B. For example, one or more lens elements 1005 are used to focus, diffuse, or otherwise condition the light reflected off of the hemi-spherical screen 102 prior to it reaching the sample measurement sensors 106A and 106B.

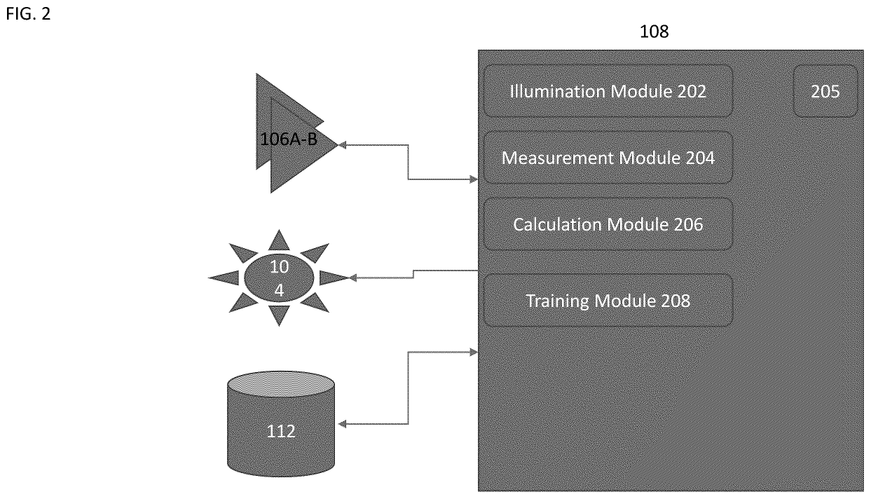

The output signal generated by sample measurement sensors 106A-B are transmitted to one or more processor(s) 108 for evaluation as a function of one or more hardware or software modules. As used herein, the term “module” refers, generally, to one or more discrete components that contribute to the effectiveness of the presently described systems, methods and approaches. Modules can include software elements, including but not limited to functions, algorithms, classes and the like. In one arrangement, the software modules are stored as software in memory 205 of processor 108, as shown in FIG. 2. Modules can, in some implementations, include discrete or specific hardware elements. In one implementation, processor 108 is located within the same device as the measurement enclosure 103, such as within the form factor of a measurement device. However, in another implementation, processor 108 is remote or separate from the measurement device and communicates over one or more communication linkages.

In one configuration, processor 108 is configured through one or more software modules to generate, calculate, process, output or otherwise manipulate the output signals generated by the sample measurement sensors 106A-B.

In one implementation, processor 108 is a commercially available computing device. For example, processor 108 may be a collection of computers, servers, processors, cloud-based computing elements, micro-computing elements, computer-on-chip(s), home entertainment consoles, media players, set-top boxes, prototyping devices or “hobby” computing elements.

Furthermore, processor 108 can comprise a single processor, multiple discrete processors, a multi-core processor, or other type of processor(s) known to those of skill in the art, depending on the particular embodiment. In a particular example, processor 108 executes software code on the hardware of a custom or commercially available cellphone, smartphone, notebook, workstation or desktop computer configured to receive data or measurements captured by the sample color sensors 106 either directly, or through a communication linkage.

Processor 108 is configured to execute a commercially available or custom operating system, e.g., Microsoft WINDOWS, Apple OSX, UNIX or Linux based operating system in order to carry out instructions or code.

In one or more implementations, processor 108 is further configured to access various peripheral devices and network interfaces. For instance, processor 108 is configured to communicate over the internet with one or more remote servers, computers, peripherals or other hardware using standard or custom communication protocols and settings (e.g., TCP/IP, etc.).

Processor 108 may include one or more memory storage devices (memories). The memory is a persistent or non-persistent storage device (such as an IC memory element) that is operative to store the operating system in addition to one or more software modules. In accordance with one or more embodiments, the memory comprises one or more volatile and non-volatile memories, such as Read Only Memory (“ROM”), Random Access Memory (“RAM”), Electrically Erasable Programmable Read-Only Memory (“EEPROM”), Phase Change Memory (“PCM”), Single In-line Memory (“SIMM”), Dual In-line Memory (“DIMM”) or other memory types. Such memories can be fixed or removable, as is known to those of ordinary skill in the art, such as through the use of removable media cards or modules. In one or more embodiments, the memory of processor 108 provides for the storage of application program and data files. One or more memories provide program code that processor 108 reads and executes upon receipt of a start, or initiation signal.

The computer memories may also comprise secondary computer memory, such as magnetic or optical disk drives or flash memory, that provide long term storage of data in a manner similar to a persistent memory device. In one or more embodiments, the memory of processor 108 provides for storage of an application program and data files when needed.

As shown in FIG. 1, processor 108 is configured to store data either locally in one or more memory devices. Alternatively, processor 108 is configured to store data, such as measurement data or processing results, in a local or remotely accessible database 112. The physical structure of database 112 may be embodied as solid-state memory (e.g., ROM), hard disk drive systems, RAID, disk arrays, storage area networks (“SAN”), network attached storage (“NAS”) and/or any other suitable system for storing computer data. In addition, database 112 may comprise caches, including database caches and/or web caches. Programmatically, database 112 may comprise flat-file data store, a relational database, an object-oriented database, a hybrid relational-object database, a key-value data store such as HADOOP or MONGODB, in addition to other systems for the structure and retrieval of data that are well known to those of skill in the art. Database 112 includes the necessary hardware and software to enable processor 108 to retrieve and store data within database 112.

In one implementation, each element provided in FIG. 1 is configured to communicate with one another through one or more direct connections, such as through a common bus. Alternatively, each element is configured to communicate with the others through network connections or interfaces, such as a local area network LAN or data cable connection. In an alternative implementation, the sample measurement sensors 106A-B, processor 108, and database 112 are each connected to a network 110, such as the internet, and are configured to communicate and exchange data using commonly known and understood communication protocols.

In a particular implementation, processor 108 is a computer, workstation, thin client or portable computing device such as an Apple iPad/iPhone® or Android® device or other commercially available mobile electronic device configured to receive and output data to or from database 112 and the sample measurement sensor 108.

In one arrangement, processor 108 communicates with a local or remote display device 114 to transmit, displaying or exchange data. In one arrangement, the display device 114 and processor 108 are incorporated into a single form factor, such as a color measurement device, such as a spectrometer, that includes an integrated display device. In an alternative configuration, the display device 114 is a remote computing platform such as a smartphone or computer that is configured with software to receive data generated and accessed by processor 108. For example, processor 108 is configured to send and receive data and instructions from a processor(s) of a remote display device 114.

This remote display device 114 includes one or more display devices configured to display data obtained from processor 108. Furthermore, display device 114 is also configured to send instructions to processor 108. For example, where processor 108 and the display device are wirelessly linked using a wireless protocol, instructions can be entered into display device 114 that are executed by the processor. Display device 114 includes one or more associated input devices and/or hardware (not shown) that allow a user to access information, and to send commands and/or instructions to processor 108. In one or more implementations, the display device 114 can include a screen, monitor, display, LED, LCD or OLED panel, augmented or virtual reality interface or an electronic ink-based display device.

Those possessing an ordinary level of skill in the requisite art will appreciate that additional features, such as power supplies, power sources, power management circuitry, control interfaces, relays, adaptors, and/or other elements used to supply power and interconnect electronic components and control activations are appreciated and understood to be incorporated.

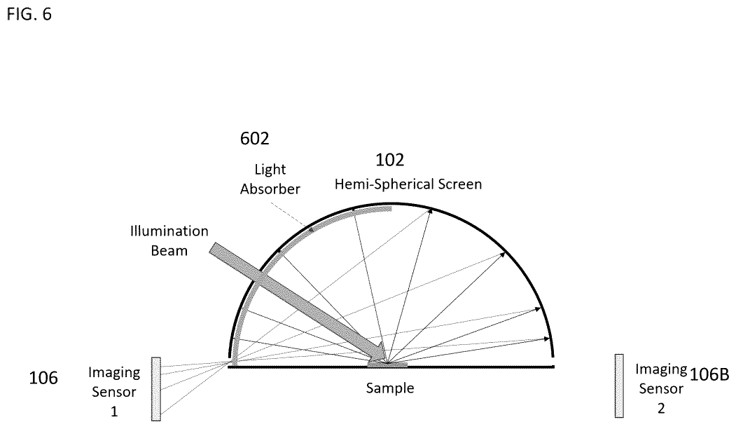

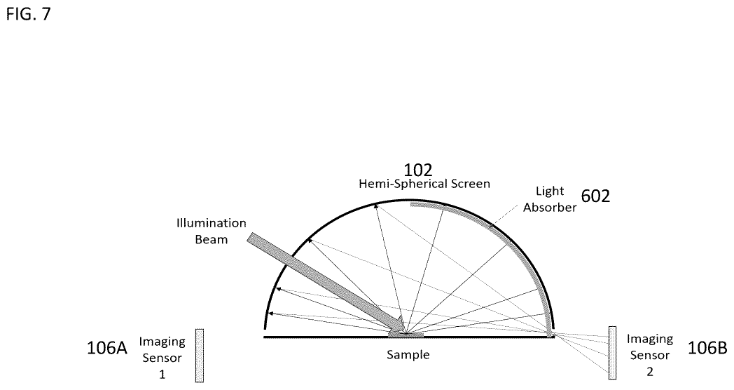

In yet a further implementation of the BRDF measurement device, as shown in FIG. 6-7, a light absorbing device is positioned between the sample 101 and a portion of the inner surface of the hemi-spherical screen and configured to absorb light reflected off the sample. In one arrangement, the light absorbing material 602 is configured to be removable. In another configuration, the light absorbing material 602 can be affixed to one-half of the hemi-spherical screen 102 at any given time.

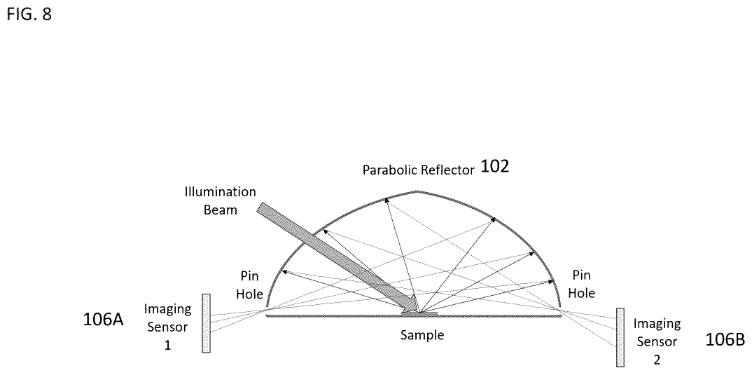

Turning now to FIG. 8, the hemi-spherical screen 102 is a parabolic reflector. In one or more configurations, the hemi-spherical screen 102 includes at least two partial parabolic reflectors. In a further arrangement, one of the focuses of each of the at least two partial parabolic reflectors are located at the sample 101 and the second one of the focuses of each of the at least two partial parabolic reflectors is located at one of the at least two openings 105 disposed within the enclosure.

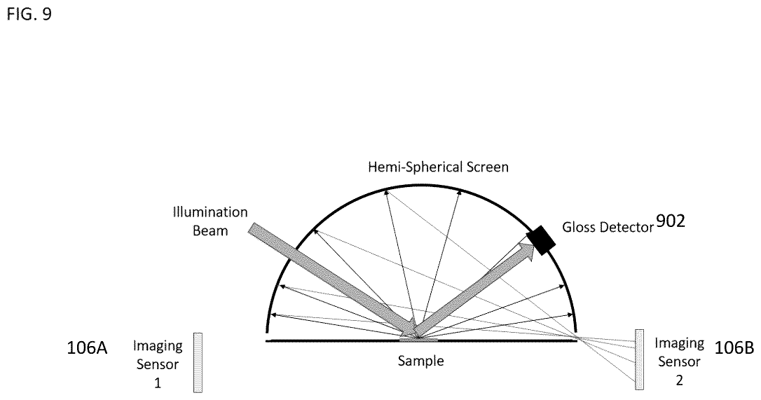

As shown in FIG. 9, the described measurement system further includes comprising a gloss detector 902 located within the enclosure and configured to output data to the processor 104. In a particular implementation, the gloss detector is positioned at the specular direction opposite to the light source. In a further arrangement, the gloss detector is a glossmeter. It will be appreciated that BRDF includes the gloss information of a sample. For example, the peak measurement value of BRDF corresponds to the gloss of the sample, such that the gloss of a sample 102 could be measured using the approaches described herein. In one arrangement, the gloss detector is used to adjust the BRDF function so that the peak measurement value matches the gloss measurement. For example, by adjusting the BRDF measurement values obtained until the peak values match the measured gloss values. In one or more further implementation, the gloss detector provides additional data, such as the gloss value of the sample under analysis.

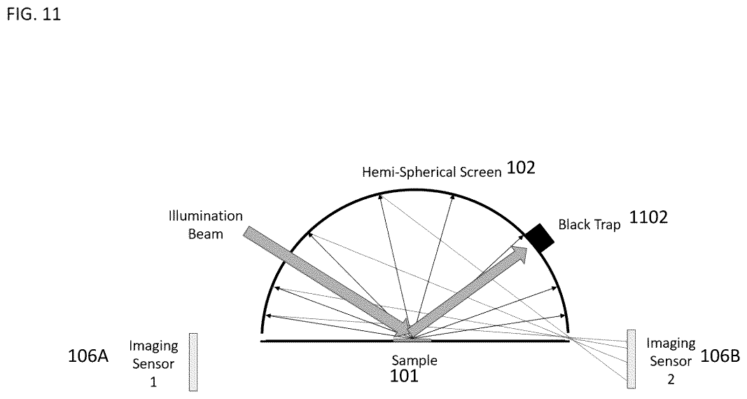

As shown in FIG. 11, the measurement enclosure is configured with a black trap 1102 having an interior volume accessible by an opening. In one arrangement, the black trap 1102 is configured with a removable cover (not shown) to cover the opening, such that when the removable cover is engaged, the inner surface of the enclosure is relatively uniform and when the removeable cover is disengaged, light passes from the interior volume of the enclosure into the opening. In this configuration, light directed into the black trap does not reach the sample measurement sensor 106A. Therefore, measurements can be obtained by sample measurement sensor 106B that excludes light directed from the sample 101 into the black trap. In one or more arrangements, the black trap can be positioned anywhere along the inner surface of the hemi-spherical screen 102.

Typically, when measuring a glossy sample, light intensity from the sample 101 towards the black trap in the specular direction is high. If this portion is scattered back into the screen 102, the BRDF result will be less accurate. With the black trap, this specular light can be absorbed and thus won't introduce extra noise (scattered light) to other part of the screen 102.

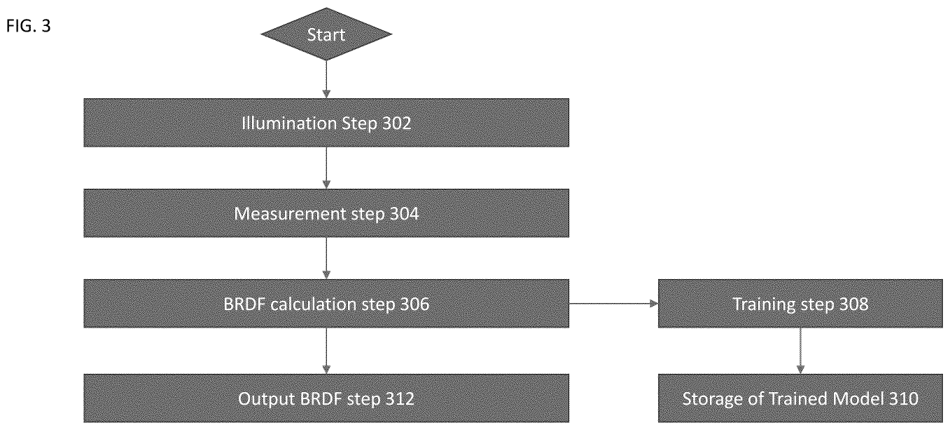

With particular reference to FIGS. 2 and 3, a process and method for calculating the BRDF of a sample is provided using the elements described herein. The approach described includes obtaining a measurement value of a sample 101 using a hemi-spherical screen 102 and obtaining, using at least one processor 108, a measurement of the sample 101. The method further includes sending an initiation signal to the one or more illuminators 104 to generate an illumination beam directed at the sample 101. For example, the processor 108 is configured by an illumination module 202, executing as code stored in the memory thereof. As shown in step 302, the processor 108 configured by the illumination module 202 causes the illuminator 104 to illuminate the sample 101. In one arrangement, the illuminator 104 is configured with one or more microprocessors that are configured to receive a control or activation signal generated by the suitably configured processor. However, in an alternative configuration, one or more direct connections between the processor 108 and the illuminator 104 is activated and causes a lighting element thereof to be activated.

Upon activation of the illuminator 104 as shown in step 302, it will be appreciated that a light beam will be directed to sample 101. As noted, the angle of the light beam, is in one or more arrangements less than 90-degrees relative to the sample normal. In one or more further implementations, the generated light beam strikes the sample at an angle that is greater than 0-degrees but less than 90-degrees. Upon striking the surface of the sample, light is reflected towards various directions according to the Bidirectional Reflectance Distribution Function (BRDF) property of a given sample. The light reflected off sample 101 will then strike the inside of the hemi-spherical screen 102 (as shown in FIG. 4). Here, the interior surface of the hemi-spherical screen 102 causes light to be scattered in various directions. It will be appreciated that the intensity of light scattered from the screen at different locations depends on the BRDF function of the sample material.

As shown in references to FIGS. 1 and 4, the hemi-spherical screen 102 is configured with two passages, channels, or holes 105 at the left-end and right-ends of the hemi-spherical screen. Light from the right-half of the hemi-spherical screen travels through the left passage 105 and reaches a first sample measurement sensor 106A. Light from the left-half of the hemi-spherical screen 102 travels through the right passage and reaches a second sample measurement sensor 106B. In general, sample measurement sensor 106A can capture the light distribution information of the right-half of the hemi-spherical screen, and sample measurement sensor 106B can capture the light distribution information of the left-half of the hemi-spherical screen.

For example, as shown in step 304, the system is configured to obtain measurements from the sample measurement sensors 106A and 106B. As shown in FIG. 2, in one arrangement, a measurement module 204 configures the processor 108 receive signals generated by the sample measurement sensors 106A and 106B in response to receiving light that have interacted with the sample and the hemi-spherical screen 102. For example, measurement module 204 configures processor 108 to receive a data stream, data file, analog signal, digital signal, or other data that corresponds to the measurement made by the measurement sensors 106A and 106B.

Once processor 108 has received the data from measurement sensors 106A and 106b, processor 108 is configured to generate the BRDF value of sample 101. For example, processor 108 is configured to evaluate the intensity of the light captured by the imaging sensors 106A and 106B. As shown, in calculation step 306, processor 108 is configured by a calculation module 206 to use the data obtained by the sample measurement sensors 106A and 106B to calculate the BRDF of the sample 101. In one arrangement, processor 108 is configured by calculation module 206 to combine the signals output by sample measurement sensors 106A and 106B to provide a full picture of the light distribution on the hemi-spherical screen. This information can thus provide a full picture of the BRDF of the sample related to the given direction of incident illumination beam. In one or more further implementations, the hemi-spherical screen 102 is used to collect the light in the 2π hemisphere, and a pin-hole imaging system, channel 105 and sensors 106A and 106B can be used to map the intensity of light distributed in the 2π hemisphere into a 2-dimensional image. From this 2-dimensional image, the BRDF of the sample material can be obtained.

By way of particular example, a processor (such as processor 108) configured by the calculation module 206 obtains the combination of the results of different imaging sensors and generates a 2-dimensional image. The intensity is a function of the location of various pixels: I_{image}=I_{image} (px, py), where px and py are coordinates of the pixels in the image. With a given incident illumination beam, the BRDF property of the sample material determines the intensity of light reflected back into the 2π hemisphere, as function of the direction relative to the sample normal: I_{BRDF}=I_{BRDF} (θ, φ), where θ is the polar angle (angle with respect to polar axis, or the sample normal), and φ is the azimuthal angle (angle of rotation from the initial meridian plane).

The optical systems described above (the pin holes and imaging sensors) can provide a one-to-one mapping between I_{BRDF} and I_{image}, and thus by obtaining the 2-dimensional image I_{image} from the combination of different imaging sensors, the BRDF, or more specifically, the light intensity I_{BRDF} reflected by the sample into the 2π hemisphere above the sample plane, can be obtained.

For example, images from the one or more different image sensors can be combined to generate an image. By way of non-limiting example, where two sensors are used, the two images generated by the imaging sensors are combined. As noted, using a left image sensor will have information relating to the right half of the 2π space. This image will include some redundant information from the left half of the 2π space. The second image, obtained by the right image sensor, has information of the left half of the 2π space (with some redundant information from the right half). The described approach includes a step of adding these two images together and removing the redundant information. This yields a new image that is twice as large and includes the full of the 2π space, these multiple images are combined or overlapped to generate a single image to obtain the 2π space information.

Using these combined images, the BRDF value can be calculated according the described relationships. Once calculated, the BRDF value can be output to a display, or data storage device, as shown in step 312.

It is understood that I_{BRDF} is also a function of the incident direction of the illumination beam, and thus by changing the incident direction of the illumination beam, different BRDFs can be obtained.

In a further implementation, the described measurement system can be calibrated. For example, the measurement device described can be used to measure a white calibration tile having a known BRDF value. Based on the comparison between the calculated BRDF value and the known BRDF value, the described measurement device can be calibrated. In a further implementation, the mapping between the 2-dimensional image I_{image} and the BRDF of the sample I_{BRDF} can be trained using artificial neural networks (ANN). For example, a training module 308 configures processor 104 or another processor to train an artificial neural network to generate measurement values for the BRDF of a sample. In one arrangement, a series of samples with various known BRDFs can be used as training samples. For each sample, a 2-dimensional image can be obtained as provided for in step 306. Using these values, the training module 308 configures a processor (such as, but not limited to processor 108) to build a database of 2-dimensional images and their corresponding BRDFs as shown in step 308. Using this database, the ANN can be trained so that in the future, when a new sample is measured and a new 2-dimensional image is obtained, the BRDF of the said new sample can be generated by the ANN. Once a model has been trained, it can be stored for further use, as in step 310. For example, in one or more implementations, processor 104 is configured to provide the measurements made by sample measurement sensors 106A and 106B to a pre-trained ANN stored in a memory accessible to the processor. This pre-trained ANN then provides the BRDF value for the sample 101 under analysis.

While this specification contains many specific embodiment details, these should not be construed as limitations on the scope of any embodiment or of what can be claimed, but rather as descriptions of features that can be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter have been described in this specification. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain embodiments, multitasking and parallel processing can be advantageous.

Publications and references to known registered marks representing various systems cited throughout this application are incorporated by reference herein. Citation of any above publications or documents is not intended as an admission that any of the foregoing is pertinent prior art, nor does it constitute any admission as to the contents or date of these publications or documents. All references cited herein are incorporated by reference to the same extent as if each individual publication and reference were specifically and individually indicated to be incorporated by reference.

While the invention has been particularly shown and described with reference to a preferred embodiment thereof, it will be understood by those skilled in the art that various changes in form and details may be made therein without departing from the spirit and scope of the invention. As such, the invention is not defined by the discussion that appears above, but rather is defined by the claims that follow, the respective features recited in those claims, and by equivalents of such features.

What is claimed is:

1. An apparatus for measuring the characteristics of a sample, comprising:
an enclosure about an interior volume containing the sample, wherein the enclosure has a reflective inner surface and at least two openings;
a light source configured to illuminate the sample within the enclosure such that light reflected from the sample and the inner surface of the enclosure passes through the at least two openings to an external environment;
at least two image sensors configured to generate output data in response to light striking a portion thereof, where the at least two image sensors are positioned to receive light exiting the at least two openings disposed within the enclosure; and
a processor configured to receive the output data from the at least two image sensors and generate, using the output data, a bidirectional reflectance distribution function (BRDF) property of the sample.

2. The apparatus of claim 1, wherein the processor is further configured output the BRDF value to one or more of a display device coupled to the processor, internal storage device accessible by the processor, or remote storage that is remotely accessible by the processor.

3. The apparatus of claim 1, wherein the inner surface of the enclosure is a light scattering material.

4. The apparatus of claim 3, wherein the inner surface of the enclosure is a diffuse white material.

5. The apparatus of claim 1, further comprising a base configured to support the sample and the enclosure, wherein the base is formed of a light absorbing material.

6. The apparatus of claim 1, wherein the light source is located outside the enclosure and the enclosure is configured with at least one light transparent portion to allow the light from the light source to reflect off the sample.

7. The apparatus of claim 1, further comprising one or more reflective elements located adjacent to each of the at least two openings.

8. The apparatus of claim 1, further comprising a light absorbing device positioned between the sample and a portion of the inner surface of the enclosure and configured to absorb light reflected off of the sample.

9. The apparatus of claim 1, wherein the enclosure is a hemi-spherical screen within an inner surface.

10. The apparatus of claim 1, wherein the enclosure comprises at least two partial parabolic reflectors.

11. The apparatus of claim 10, wherein a first one of the focuses of each one of the at least two partial parabolic reflectors is located at the sample and a second one of the focuses of each of the at least two partial parabolic reflectors is located at one of the at least two opening disposed within the enclosure.

12. The apparatus of claim 1, wherein the enclosure is configured with at least three openings and at least three image sensor devices.

13. The apparatus of claim 1 further comprising a gloss detector located within the enclosure and configured to output data to the processor.

14. The apparatus of claim 13, where the gloss detector is positioned at the specular direction opposite to the light source.

15. The apparatus of claim 14, where the gloss detector is a glossmeter.

16. The apparatus of claim 1, wherein the enclosure is configured with a black trap having an interior volume accessible by an opening, wherein the black trap is configured with a removable cover to cover the opening, such that when the removable cover is engaged, the inner surface of the enclosure is relatively uniform and when the removeable cover is disengaged, light passes from the interior volume of the enclosure into the opening.

17. The apparatus of claim 1, wherein the inner surface of the enclosure is configured with a plurality of reflective elements disposed on a light absorbing base.

18. A method of measuring the characteristics of a sample, comprising:
providing an enclosure about an interior volume containing the sample, wherein the enclosure has a reflective inner surface and at least two openings;
a light source configured to illuminate the sample within the enclosure such that light reflected from the sample and the inner surface of the enclosure passes through the at least two openings to an external environment;
at least two image sensors configured to generate output data in response to light striking a portion thereof, where the at least two image sensors are positioned to receive light exiting the at least two openings disposed within the enclosure; and
a processor configured to receive the output data from the at least two image sensors and generate, using the output data, a bidirectional reflectance distribution function (BRDF) property of the sample;
illuminating the sample with the light source;
obtaining a measurement value generated by the at least two image sensors;
calculating, using the processor, bidirectional reflectance distribution function, by combining the measurement values generated by the at least two image sensors into a single two-dimensional image.
